(19) United States
(12) Patent Application Publication
(10) Pub. No.: US 2014/0116875 A1
(43) Pub. Date: May 1, 2014

(54) Heat Exchange Elements for Use in Pyrometallurgical Process Vessels

(71) Applicant: BHP BILLITON ALUMINIUM TECHNOLOGIES LIMITED, St Helier, Jersey (GB)

(72) Inventors: Ingo Bayer, London (GB); Bruce Ringsby Olmstead, Pretoria (ZA)

(21) Appl. No.: 14/004,722

(22) PCT Filed: Apr. 5, 2012
(86) PCT No.: PCT/EP2012/056337

§ 371 Date: Jan. 14, 2014

(30) Foreign Application Priority Data
Apr. 8, 2011 (AU) 2011901327

(51) Int. Cl. C25C 7/00; F27D 17/00

(52) U.S. Cl. CPC C25C 7/005; F27D 17/004
USPC 204/245; 266/168

(57) ABSTRACT

A pyrometallurgical vessel for the production of metal by the electrolytic reduction of a metal bearing material dissolved in a molten salt bath, the cell including a shell 11 and a lining 12,13 on the interior of the shell, the lining including a bottom cathode lining 13 and a side wall lining 12, at least one of the bottom cathode lining 13 and a side wall lining 12 including a plurality of fluid ducts 16, 22, 31, 41 positioned within the lining for conducting a fluid therethrough, the flow of fluid through the ducts within the linings having 3-dimensional directional flow provided by 3-dimensional shapes inserted into the ducts or the ducts comprising a number of straight sections joined by curved sections arranged in a 3-dimensional shape, the 3-dimensional shapes of the ducts or the 3-dimensional shapes inserted into the ducts. The 3-D shapes in the ducts or the 3-D shape of the ducts are in such a way that secondary flows in the fluid are formed, broken and reformed imparting greater advection in the flow.

### FIELD OF THE INVENTION

This invention relates to process vessels used in pyrometallurgical processing applications and in particular to a heat exchanger arrangement which may be included in the refractory lining of these vessels for the purposes of controlling the heat flow through the lining of the vessel and for recovering the waste heat which passes through the lining.

### BACKGROUND OF THE INVENTION

Pyrometallurgical processing of metals and their ores occurs at high temperatures, typically in excess of 100° C. and frequently well in excess of 900 ° C. Owing to the high process temperatures and the frequently aggressive nature of the process materials, such pyrometallurgical process vessels are commonly lined with relatively thick layers of refractory materials which serve amongst other purposes, to insulate the process from ambient conditions. Operation of a chemical process at such temperatures implies that significant amounts of energy must be expended solely in achieving and maintaining the process temperature. The energy expended in heating the vessel serves only to provide for the process environment, and is ultimately lost to the surroundings as waste heat.

Although the concepts and claims made in this application are generally framed in terms of an aluminium reduction process, this invention is equally applicable to the capture of waste heat from a wide range of pyrometallurgical processes. These processes may be either continuous or batched in nature; waste heat escaping through the vessel linings resulting from the provision of a high-temperature environment for their contained processes is the requisite common factor between them. This invention relates to the capture of that waste heat from the process within the vessel refractory linings and does not specifically relate to the time frame in which that heat is collected.

Modern commercial smelting of aluminium, using typical electrolysis cells of the so-called Hall-Héroult type, is a very energy-intensive process. Practical operation of these cells typically requires of the order of 12-14 MW-hrs of electricity to produce a tonne of aluminium metal, with only about 40% of that power used in the process of reducing alumina to aluminium metal. The reduction process is continuously operated at high temperatures, and the remaining power entering the cells is converted to heat and is ultimately wasted from the cells to ambient.

The aluminium reduction process is not only dependent upon continuous high temperatures; it is also chemically harsh, subjecting the reduction vessel to high-temperature chemical reactions—involving fluorides, amongst other highly reactive chemical species—which are particularly detrimental to most high-temperature refractory materials which might be used to line the reduction vessels. For this purpose, it is well-known to practitioners in the field that it is essential to maintain and control a freeze lining on the inner surface of the refractory linings of the reduction vessel in order to protect them during smelting operations. Bayer, in US 2007/0187230, teaches that the development and control of this freeze lining may be constructively aided by the addition of cooling channels in the side linings of the reduction vessel, with air circulating in those channels selectively removing heat from the lining.

Air circulating in the hot linings of a reduction cell will naturally be heated by convection and the heat contained in such air may be used for various purposes, including preheating the feed flow of alumina to the process (as taught by Eyvind and Holmberg in WO 83/1631) or in the generation of electricity, as taught by Holmen in WO 2006/031123 and Aune, et al, in WO 01/94667. It is the collection of waste heat for the generation of electricity which is of most interest in the present disclosure.

In considering the recovery of waste heat for the purposes of generating electricity it is important to recognise that the total system efficiency and safety are of paramount importance in developing the collection and generation processes. In WO 01/94667, Aune, et al suggest using evaporative cooling based on the liquid to gas phase change of a metal, such as sodium. While sodium offers good heat transfer properties, it is costly and there is a risk of explosive liquid-gas phase changes in the event of direct contact with liquid aluminium. It also poses a fire risk in the event of contact between the liquid sodium and air, as might happen if the piping containing the liquid sodium were damaged during use. Moreover, WO 01/94667 teaches that evaporative cooling applications would beneficially make use of a plurality of closed-loop heat exchangers, each of which would involve temperature drops in the heat transfer fluid, thereby adversely affecting the overall efficiency of the heat recovery system.

In WO 2006/031123, Holmen teaches that air represents a more sensible cooling medium for an electrolysis cell, in that it does not need a maintenance-intensive closed loop system for its operation. In WO 2006/031123 however, the primary intention of the disclosure is that of cooling the electrolysis cell, with the removed heat routed through a turbocharger arrangement to recover some portion of the contained energy. No attempt is made to consider the efficiency of the heat recovery portion of the process.

Siljan, in WO 2004/083489, teaches that simple mould-making techniques may be applied to the manufacture of reduction cell lining components to provide refractory panels through which a heat transfer fluid might flow. Although air is mentioned as a suitable heat transfer fluid, special-purpose gases and liquids are also mentioned as appropriate media. The mould-making applications disclosed in WO 2004/083489 are restricted to planar major geometries, such as straight tubular segments or tubular serpentines, wherein the duct geometries are formed on the interior portions of a two-component sandwich of sintered refractory material. It is also disclosed that the cross-section of these ducts might be formed as containing protrusions in the direction of the axis of the ducting in order to increase the surface area through heat which might be transferred. WO 2004/083489 makes no mention of the energy required to cause a heat transfer fluid, such as air, to flow through these channels. While both the basic channel geometries and the means by which they might be formed are well-known to practitioners knowledgeable in the field, their application in refractory panels which might be used in the lining of electrolytic cells represents the principal relevant disclosure of WO 2004/083489.

System efficiency of a heat exchanger may be described in terms of the heat added to or removed from the heat transfer fluid passing through it and must include a measure of the dissipation of energy due to friction between the fluid and the heat exchanger components. Optimal efficiency relates to maximising the heat content of the heat transfer fluid typically indicated by its temperature and flow rate while simultaneously minimising the energy dissipation, as measured for instance by the pressure drop in the fluid passing through the heat exchanger.

In heat exchanger configurations such as the primary heat exchanger proposed for use in the linings of electrolysis vessels, heat is added to the contained fluid through direct contact with the hot boundaries of the fluid channels, and is distributed through the fluid by means of combination of diffusion and convection and/or advection processes. Diffusive heat transfer processes dominate in the thermal boundary layer close to the surfaces of the fluid channels, and to be practically effective rely upon a large difference in temperature between the flowing fluid and the channel boundary. Such diffusive heat transfer will occur in either stationary or moving fluids. Advective and convective heat transfer processes relate to the transport of heat by movement of the heat-containing medium, and positively serve to mix the heated fluid with cooler portions of the fluid, thereby assisting with the overall transfer of heat into or out of the heat transfer medium. Generally, a greater degree of mixing (or advection) in its contained fluid is beneficial to the thermal efficiency of a heat exchanger.

Although the dominant fluid motion in a heat exchanger consisting of well-defined channels or tubes is clearly along the axis of those channels, persistent secondary flows causing additional motion in a plane transverse to the main channel axis may be caused by introducing large-scale three-dimensional shapes into the channels. These may be in the form, either singly or in combination with each other, of helical inserts into the channels, helical shapes protruding from the channel boundaries, or on an even larger scale, may relate to helical or other three-dimensionally curved or sectional geometries for the channels themselves. The mixing imposed by these three-dimension geometries as disclosed in this invention significantly enhances the heat transfer into the channel, thereby improving the thermal efficiency of the heat exchanger in which these channels are installed over that of heat exchangers using the two-dimensional geometries disclosed by Siljan in WO 2004/083489.

Three-dimensionally curved channels can be manufactured into refractory materials used in lining electrolysis vessels using simply-moulded sections, which retain the moulded shape on firing or sintering. The three-dimensional geometry as described in this invention however precludes the use of two-component assemblies, as taught by Siljan in WO 2004/083489. Most regular geometries of interest can however be formed using a three-component assembly, where each of the components is moulded and joined into the full assembly using ceramic cements or other joining material.

Accordingly, it is an object of the present invention to provide a means by which heat passing through the lining of an electrolytic vessel used for the production of aluminium may be most efficiently extracted from the lining both to control the development of a freeze lining within the vessel, and to recover a significant portion of the heat wasted through the vessel refractories for conversion to electrical energy or other forms useful to the aluminium reduction process.

Reference to any prior art in the specification is not, and should not be taken as, an acknowledgment or any form of suggestion that this prior art forms part of the common general knowledge in any jurisdiction or that this prior art could reasonably be expected to be ascertained, understood and regarded as relevant by a person skilled in the art.

### SUMMARY OF THE INVENTION

According to one aspect of the invention, there is provided a pyrometallurgical vessel for the production of metal by the electrolytic reduction of a metal bearing material, the vessel including
a shell and
a lining on the interior of the shell, the lining including
a bottom cathode lining and a side wall lining, at least one of the bottom cathode lining and a side wall lining including a plurality of fluid ducts positioned within the lining for conducting a fluid therethrough, the flow of fluid through the ducts within the linings having 3-dimensional directional flow provided by 3-dimensional shapes inserted into the ducts or the ducts comprising a number of straight sections joined by curved sections arranged in a 3-dimensional shape.

The purpose of the changes in geometry is to successively form, break and re-form the secondary flows in the ducts in such a way that greater advection is caused in the flow.

In a further aspect, the invention provides a pyrometallurgical vessel for the production of metal by the thermal or other reduction of a metal bearing material, the cell including
a shell and
a lining on the interior of the shell, the lining including
a refractory lining, including a plurality of fluid ducts positioned within the lining for conducting a fluid therethrough, the flow of fluid through the ducts within the linings having 3-dimensional directional flow provided by 3-dimensional shapes inserted into the ducts or the ducts comprising a number of straight sections joined by curved sections arranged in a 3-dimensional shape.

As above, the purpose of the changes in geometry of the 3-D shapes is to successively form, break and reform the secondary flows in such a way that greater advection is caused in the flow.

In one preferred form of either of the above aspects, in order to provide 3-d directional flow, the ducts in the linings have directional variations in 3-dimensions. Preferably the directional variations are provided by the duct being a three-dimensionally curved shape comprising a number of straight sections joined by curved sections.

In another preferred form, the ducts are aligned in a 2-dimensional plane and 3-dimensional shapes are inserted into these 2-dimensional ducts. One preferred insert providing 3-D directional flow has variations in the height and length of the 3-d shapes along the length of the ducts. Preferably, the inserts are helical inserts into the channels or helical shapes protruding from the channel boundaries.

The pyrometallurgical vessel may be an electrolytic cell for the production of metal by the electrolytic reduction of a metal bearing material (e.g. aluminium oxide, called alumina) dissolved in a molten salt bath. The fluid ducts extend within the side wall lining and/or the bottom cathode lining of the vessel have a means such as a pump or fan, which would cause the fluid to flow through the ducts. These ducts and the fluid flowing through them may be considered to be a heat exchanger.

In the context of this invention, the side walls of the vessel are the longitudinal side walls and end walls of the cell.

In a further aspect the invention provides a method of operating a pyrometallurgical vessel for the production of metal by the thermal or other reduction of a metal bearing material, the cell including a shell and a lining on the interior of the shell, the method including the steps of
reducing the metal bearing material in a bath of metal bearing material and refractory in the cell;
forming a freeze lining or ledge of refractory material on the lining of the cell by passing a flow of coolant through a plurality of fluid ducts positioned within the lining for conducting a fluid therethrough, the flow of fluid through the ducts within the linings having 3-dimensional directional flow provided by 3-dimensional shapes inserted into the ducts or the ducts comprising a number of straight sections joined by curved sections arranged in a 3-dimensional shape the 3-D shapes having changes in shape to successively form, break and reform the secondary flows in such a way that greater advection is caused in the flow within the duct.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF THE DRAWINGS/FIGURES

FIG. 1 is a sectional view of an electrolytic cell in accordance with this invention;

FIG. 2 is an isometric view of a first embodiment of ducting within the side panel of the electrolytic cell, depicting three-dimensional ridges which are located on the inner surface of the ducts;

FIG. 3 is an isometric view of a second embodiment of the invention showing helical duct located within the side panel of an electrolytic cell;

FIG. 4 is an isometric view of a third embodiment of the invention showing a modified helical duct located within the side panel of an electrolytic cell;

FIG. 5 is an isometric view of a duct shape of the prior art; and

FIGS. 6(a), 6(b), and 6(c) are Poincaré sections which represent respectively the transverse velocity development in a straight pipe, a serpentine pipe as disclosed in the prior art (Siljan in WO 2004/083489 and illustrated in FIG. 5), and the chaotic coil (FIG. 4) disclosed herein

### DETAILED DESCRIPTION OF THE EMBODIMENTS

It will be understood that the invention disclosed and defined in this specification extends to all alternative combinations of two or more of the individual features mentioned or evident from the text or drawings. All of these different combinations constitute various alternative aspects of the invention.

It will further be understood that while the principal embodiments of this invention are stated in terms of a direct application to the aluminium electrolysis process and its equipment, the invention is similarly applicable to any pyrometallurgical process vessel in which the heated process materials are contained within a vessel which is lined with refractory components through which excess heat is wasted from the process to ambient.

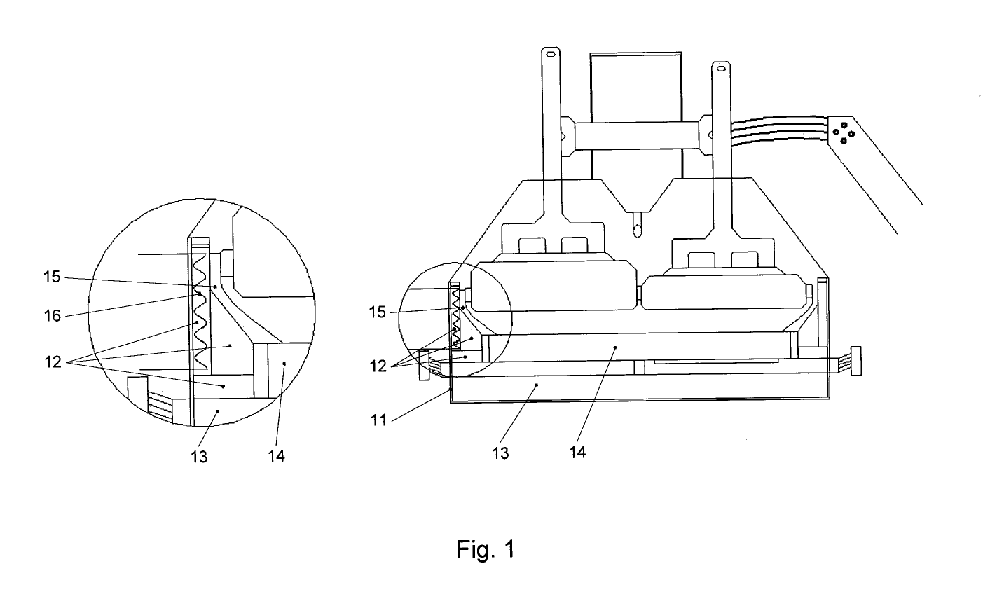

In the cross-sectional view of the electrolytic vessel shown in FIG. 1, the construction of the vessel consists of a steel shell (11), refractory side lining components (12), refractory and insulating sub-cathode lining components (13) and carbonaceous cathode blocks (14). The lining components (12), (13) are formed using a plurality of blocks, bricks and/or pre-formed panels of suitable materials to resist the thermal and chemical environment in which the electrolytic process operates. Each of these components is installed individually, and may be bonded to its neighbouring components by means of ceramic mortars, cements or other high-temperature sealing and/or adhesive compounds.

In a electrolytic cell, the side lining and bottom lining are made of refractory materials, including but not restricted to carbonaceous materials and ceramics typically made from oxides, nitrides, carbides or borides of aluminium, titanium, magnesium, zirconium or silicon, or combinations of those materials or compounds. These refractory components may also be present in the form of cemented or fused composites made from the basic refractory materials. In the instance of aluminium electrolysis, the material of choice is frequently silicon nitride-bonded silicon carbide.

The freeze lining or ledge (15) which forms against the refractory components is an essential part of the vessel lining, as it serves to protect the refractories against the harsh chemical environment of the liquids contained in the vessel. This freeze lining forms as the process electrolyte is cooled below its liquidus through contact with the refractory lining components; those components being of a lower temperature than that of the process liquids due to their being on the conduction path by which heat leaves the vessel during its operation.

It is common to most refractory applications in pyrometallurgy that many of the refractory components, such as the side linings of aluminium electrolysis cells, are in the form of rectangular panels, which are commonly located near, or in contact with, the molten materials contained within the cell. The high temperatures encountered by these panels indicate that they would be ideally situated for heat exchanger applications, both for the recovery of thermal energy passing though the sides of the electrolysis vessel, and for the control of freeze linings within the vessel. It is thus in these components that this invention seeks to locate ducts which would enable these panels to serve efficiently as heat exchangers and thermal control devices in addition to their more common containment function. The location of these ducts as they would be used in an aluminium electrolysis cell is illustrated in FIG. 1.

When operating electrolytic vessels of this type, it is advantageous to be able to control the heat passing through the refractory lining components in order to control the formation of the freeze lining and to assist in recovering the waste heat from the process. In this invention, heat transfer ducts (16) which are built into certain of the refractory lining components to remove heat from the lining in a controlled manner, thereby providing a means of regulating the thickness of the freeze lining (15) and in transferring the heat to a fluid flowing through the ducts, enable its recovery in a useful form, such as electrical energy, at another location.

In the interests of operating the electrolysis vessel in a safe manner in the event of its hot liquid contents leaking into the lining, the fluid flowing in the ducts must not be rapidly reactive to any of its possible environmental components at high temperatures, nor must it be subject to explosive phase changes when rapidly heated. Although other fluids may also have these properties, air, its stable components such as nitrogen, or any of a range of inert gases or gas mixtures are suitable as a heat transfer medium. Pumps, fans, blowers or other motive means well known to practitioners versed in the art are used to force the heat transfer fluid through the ducts in the vessel lining.

The electrolytic vessel lining and the heat exchanger ducts built into the linings can be considered as an operational system, with energy entering the system from the vessel's liquid contents, removed via the heat transfer fluid and lost to the system through such parasitic energy use as fans, etc. Clearly, due to inefficiency in the heat exchanger ducts, a portion of the heat passing through the lining may by-pass the ducting and not be captured, also affecting the efficiency of the system. The system efficiency, including parasitic losses of this heat exchanger arrangement, is critical to its successful operation, both in terms of its control over the vessel freeze lining and the energy it ultimately recovers in the heat transfer fluid.

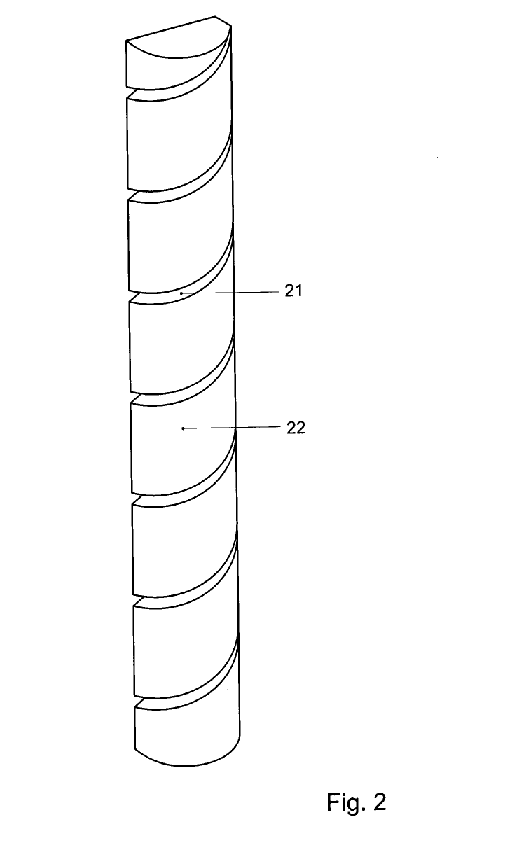

In this invention, its system efficiency is increased by the introduction of favourable secondary flows within the heat transfer fluid; which flows are established by providing suitable three-dimensional geometries in the shape of the heat transfer ducts. Three-dimensional duct shapes, while providing scope for improved heat transfer, also generally increase the fluid friction in the duct, thereby increasing parasitic energy losses, through increased fan or pump requirements. Although not exclusive, geometries which provide for beneficial secondary flows in the heat transfer fluid include helical ridges in the inner boundary of the ducts, helical ducts of a variety of cross-section or modified helices, as illustrated in FIGS. 2, 3 and 4.

It is well-known that fluid flowing through ducts which are at a different temperature to the surroundings will transport heat to or from the surroundings until it is at the same temperature as its surroundings. In shaping those ducts so as to impart a distinct three-dimensional character to the directional flow of the fluid through them advection of heat within the ducts is significantly improved, leading to an improvement in heat transfer efficiency. This increased heat transfer arises from the secondary flows imposed upon the flowing fluid by the three-dimensional geometry of the ducts. In practical terms this increased heat transfer efficiency is translated either to increased temperature changes in the heat transfer fluid or to a reduced length needed for the heat exchanger ducting.

One preferred form of the invention, illustrated in FIG. 2, discloses a duct shape distinguished by helical protrusions (21) from at least a portion of the wall of the duct (22). These protrusions serve to introduce a helical secondary flow in the fluid passing through the duct thereby improving heat transfer to the fluid flowing in the duct. The extent of these ridges is such that a substantial part of the duct—typically greater than 5%, more preferably greater than 10% and typically less than 50%, more preferably less than 40% of the main cross-sectional duct dimension—is interrupted by their presence, thereby introducing a swirling secondary flow to at least part of the fluid passing through the duct.

The cross-sectional shape of the ridges in this embodiment of the ducting is of regular geometry, formed generally from linear or curvilinear segments, or combinations thereof formed as part of the duct walls. The shape and dimension (especially height and length) of these ridges may beneficially change along the axis of the ducts, which variation in shape would beneficially aid advection of heat within the duct. Although the protrusions indicated in FIG. 2 are of triangular cross-section, any of a number of polygonal and/or curvilinear shapes may be used.

In this embodiment of the invention, the central axis of the duct lies such that the complete periphery of the duct is contained within the refractory panel. This axis may be straight, curvilinear or a combination of straight and/or curvilinear segments which will most advantageously access heat passing through the side lining of the electrolysis vessel.

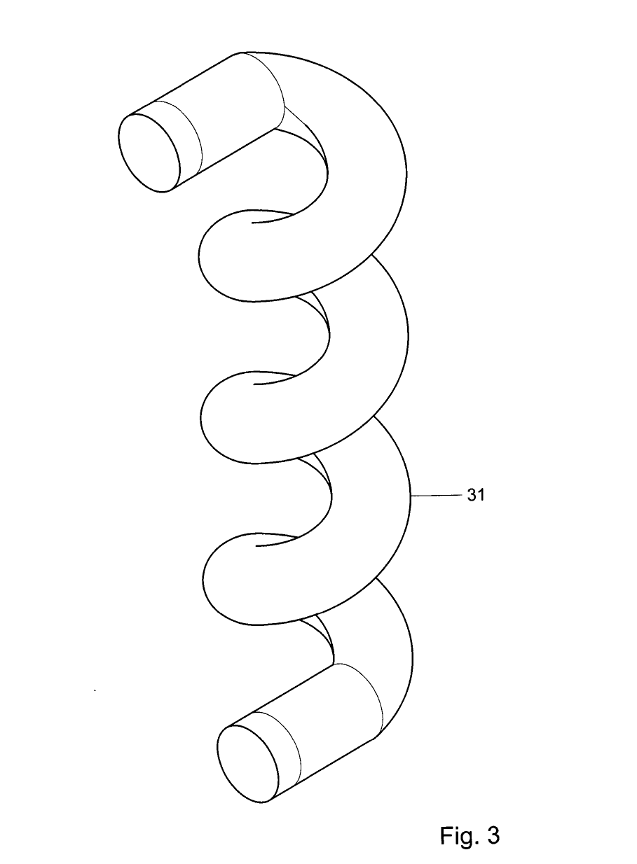

In a second preferred form of the invention, illustrated in FIG. 3, there is disclosed a helical duct shape (31) This helical duct shape imparts a secondary motion in the fluid in the form of two counter-rotating vortices having their axes of rotation along the axis of the helix. The rotating motion in these Dean vortices serves to mix the flow in the helical duct.

These helical heat exchanger ducts are positioned in the interior of refractory panels which are used as a side lining component within the electrolysis cell. A fluid, preferably such as air, flowing through these ducts develops, as a result of the helical geometry, characteristic secondary flows, which serve to mix the flowing fluid transversely through the cross-section of the ducts simultaneously with its motion along the axis of the duct, thereby improving advection of heat within the heat transfer fluid.

The cross-sectional shape of the helical duct may be of circular, polygonal or other closed shape consisting of linear and curvilinear segments, and may contain within duct channel any of a number of protruding forms, such as fins, coils, or other surface irregularities, as part of its interior structure. The cross-sectional shape of the helical duct may also vary in size or form along the length of its curving axis, which variation in shape may also aid in increasing the advection of heat within the helical duct.

In this embodiment of the invention, the main central axis around which the helix is constructed lies such that the helical ducts are fully contained within the refractory panel and do not interfere with adjacent segments of the helix. While it is most likely that the main central axis is linear and located vertically within the refractory panel when it is installed, the main central axis may be of any linear or curvilinear shape which will most advantageously access heat passing through the side lining of the electrolysis vessel.

The curving path of the helix also serves to stabilise the flow's transition to turbulence, thereby reducing the pressure drop through the duct. Although the helical duct as depicted in FIG. 3 is circular in cross-section, any of a number of polygonal and/or curvilinear cross-sectional shapes may be employed for this embodiment.

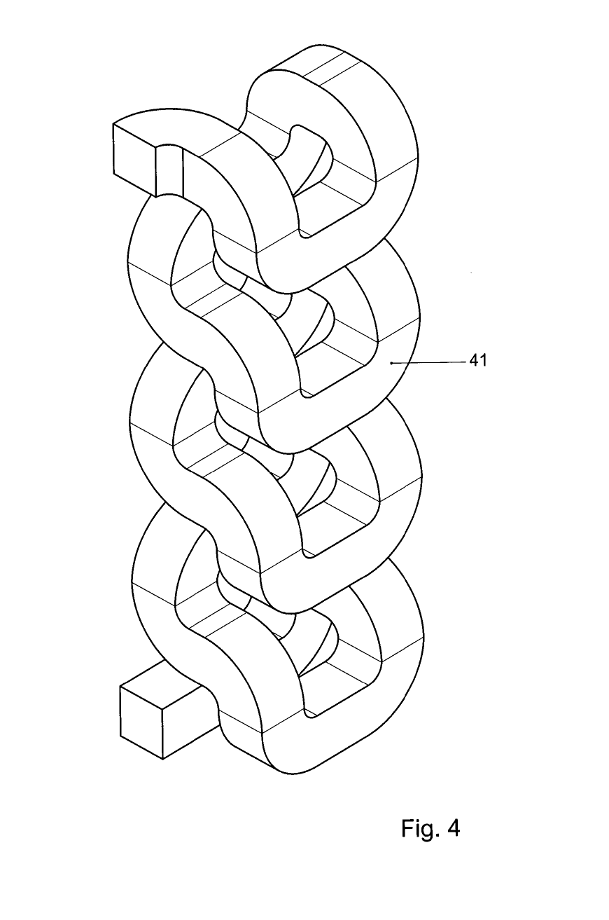

In a third preferred embodiment of the invention, FIG. 4 discloses a modified helical duct (41) wherein the curvature in the duct's main direction lies successively in two mutually orthogonal directions. This shape is characterised by curvatures in two different directions with the overall form of the ducts again directed around a common main central axis. Fluid flows in curving ducts of this type again remain laminar in nature due to the curvature of the main flow path, but due to the changing direction of the axis of curvature are unable to form the characteristic Dean vortices associated with helical flow paths. The flowing fluid instead develops a chaotic motion, characterised by random swirls and folds caused by secondary velocity fields acting transversally to the main flow direction. These serve to thoroughly mix the fluid in its path through the duct.

Although the duct depicted in FIG. 4 is square in cross-section, any of a number of polygonal and/or curvilinear cross-sectional shapes may be employed in defining the modified helical ducts. The duct of FIG. 4 consists of a combination of linear and curved sections arranged in a 3-D arrangement. The curved sections shown are half circle and quarter circle turns but the invention is not necessarily restricted to 90 and 180 degree curved sections.

The advantage found in using this doubly-curved geometry lies firstly in its ability to present a larger portion of its duct periphery to the hottest side of the lining panel, thereby exposing more surface area to a greater temperature. The double curvature also constructively interrupts the regular formation of the Dean vortices associated with a helix having a single curvature, and instead gives rise to large-scale chaotic secondary flow which is noted for more efficient thermal advection than is present in more conventional laminar flows, even if the advection is aided by common secondary flow regimes.

While the cross-sectional shape of this embodiment is shown in FIG. 4 to be square, other regular shapes, such as circles, polygons or other closed shapes consisting of linear or curvilinear segments, may also be employed in this embodiment. The cross-sectional shape of the duct may also vary in size or form along the length of its curving axis, which variation in shape or form may also aid in increasing the advection of heat within the duct.

In a preferred form of this invention, air passing through the three-dimensional ducting lying within the lining of an electrolytic cell as disclosed in this application will be heated by contact with the lining components; which heat may be regarded as recovered waste heat from the electrolysis process. The heated air is then passed through energy recovery modules, employing thermoelectric, thermo-magnetic, organic Rankine cycle or other means known to those versed in energy recovery processes for conversion of the energy contained in the air to electricity.

### Substantiation of the Invention

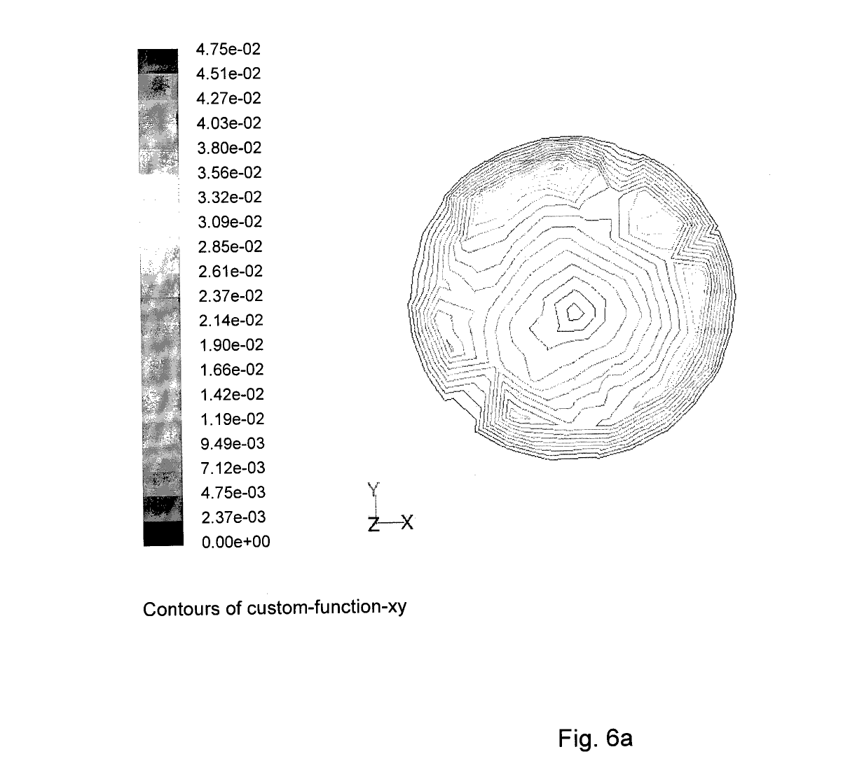

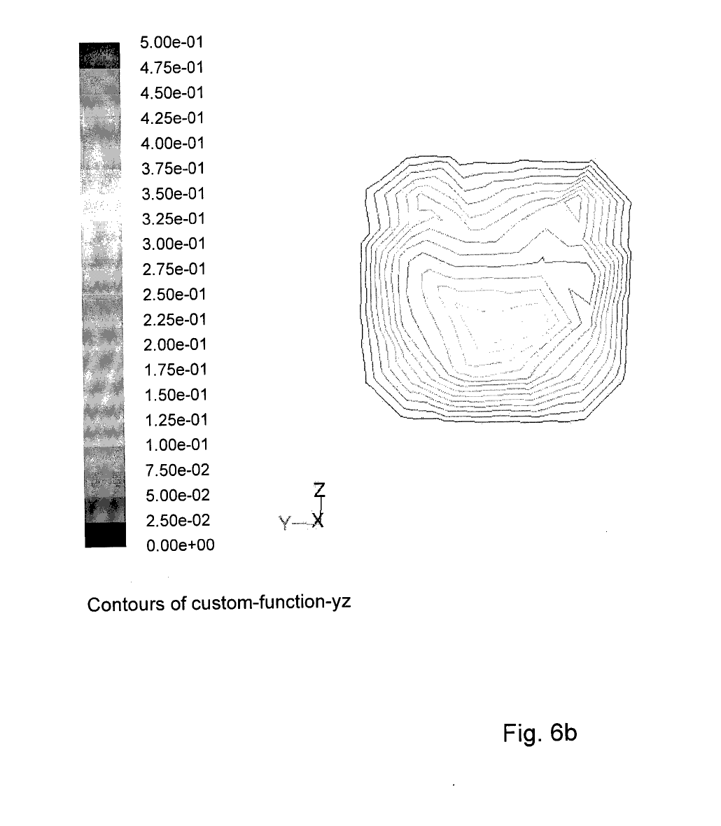

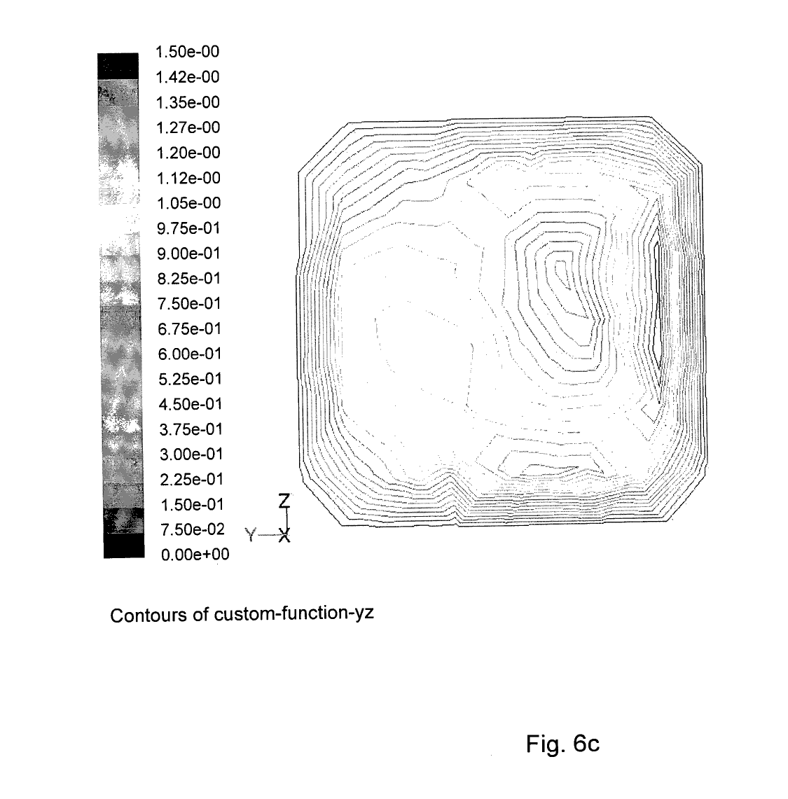

This invention discloses a means to improve the heat transfer capability of fluids flowing in ducts by inducing transverse mixing flows by use of appropriate three-dimensional geometries for the path of the duct. Substantiation of the development of these mixing flows may be obtained by the calculated Poincaré sections of the transverse duct flow velocities as depicted in FIG. 6. The velocities depicted in these sections are only the transverse components acting within and normal to the main duct flow direction.

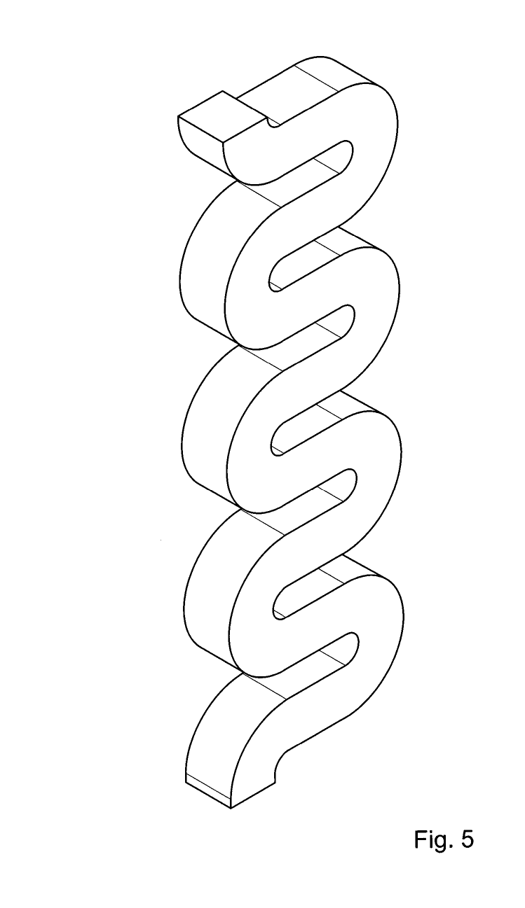

The Poincaré sections shown in FIG. 6 represent respectively the transverse velocity development in a straight pipe, a serpentine pipe as disclosed Siljan in WO 2004/083489 and illustrated in FIG. 5, and the chaotic coil (FIG. 4) disclosed herein. Little or no transverse flow outside the boundary layer is apparent in the straight pipe flow shown in FIG. 6a. The sections for the serpentine pipe shown in FIGS. 6b shows the development of weak transverse flows, which do not fully develop due to viscous forces and the opposing nature of the curves in the duct. The Poincaré section taken for the square modified helical coil shown in FIG. 6c presents a strongly-developed transverse secondary flow, as disclosed in this invention.

The effectiveness of this invention may be substantiated numerically by simulating heat flows through an assembly of materials representing a construction of a segment of the side wall of an electrolysis cell. Numerical simulations of the heat flux into a segment of the wall structure and its capture by air flowing through the ducts disclosed in this invention are performed using the computational fluid dynamics computer code FLUENT. In the instance of each three-dimensional duct shape, the duct effectiveness in capturing heat passing through the materials is compared with the heat capture effectiveness of a single straight circular duct in the same material arrangement.

Table 1 below presents comparisons of heat capture efficiency and air temperature for the three embodiments disclosed in this patent as compared with two-dimensional duct geometries. In each instance the principal cross-sectional dimension of the duct modelled is taken as approximately 30 mm and the mass flow rate of air through the duct is 0.00175 kg/sec. A total heat input of 367.52 W was available for transfer to the air in the duct along the 350 mm height of the computational test section.

TABLE 1
Duct Shape Comparison

| | Heat Capture | Exhaust Air |
|---|---|---|
| | Efficiency, | Temperature, |
| Duct Shape | % | ° C. |
| Straight Circular Duct | 69 | 177 |
| Spiral Surface Features | 74 | 141 |
| Circular Helix | 82 | 198 |
| Square Serpentine | 82 | 191 |
| Square Modified Helix | 97 | 230 |

Comparison of the data in Table 1 should take into consideration the cross-sectional shape of the duct and the surface area most exposed to the heated surface. In Table 1 therefore, the first three embodiments (“Straight Pipe”, “Spiral Surface Features”, as shown in FIG. 2, and “Circular Helix”, as shown in FIG. 3) should be compared with each other, and the final two embodiments (“Square Serpentine” as shown in FIG. 5 and “Square Modified Helix” as shown in FIG. 4) should be compared. In each instance, the embodiments leading to enhanced transverse mixing flows demonstrate improved heat capture efficiency.

It will be understood that the invention disclosed and defined in this specification extends to all alternative combinations of two or more of the individual features mentioned or evident from the text or drawings. All of these different combinations constitute various alternative aspects of the invention.

1. A pyrometallurgical vessel for the production of metal by the electrolytic reduction of a metal bearing material dissolved in a molten salt bath, the vessel, including
a shell and
a lining on the interior of the shell, the lining including:
a bottom cathode lining and a side wall lining, at least one of the bottom cathode lining and the side wall lining including a plurality of fluid duets positioned within the lining for conducting a fluid therethrough, the flow of fluid through the ducts within the linings having 3-dimensional chaotic flow provided by
a. 3-dimensional ridges located on the inner surface of the ducts within the ducts: the height and length of the 3-dimensional ridges varying along the length of the ducts such that 5 to 50% of the main cross-sectional dimension of the duct is interrupted by the presence of the ridges; or
b. the ducts arranged in a 3-dimensional geometry comprising a number of straight sections joined by curved sections; the direction of the ducts in the lining having variations in 3 -dimensions.

2. (canceled)

3. (canceled)

4. The vessel of claim 1 wherein the duets in (a) of claim 1 are aligned with variations in 2-dimensions and the 3-dimensional ridges are positioned within these ducts.

5. (canceled)

6. The vessel of claim 1 wherein the 3-D ridges in part (a) are protruding forms on the inner surface of the ducts.

7. A pyrometallurgical vessel for the production of metal by the thermal or other reduction of a metal bearing material, the vessel including:
a shell and
a lining on the interior of the shell, the lining including
a refractory lining, including a plurality of fluid ducts positioned within the lining for conducting a fluid there through, the flow of fluid through the ducts within the linings having 3-dimensional chaotic flow provided by:
a. 3-dimensional ridges located on the inner surface of the ducts within the ducts; the height and length of the 3-dimensional ridges varying alone the length of the ducts such that 5 to 50% of the main cross-sectional dimension of the duct is interrupted by the presence of the ridges; or
the ducts arranged in a 3-dimensional geometry comprising a number of straight sections joined by curved sections; the direction of the ducts in the linings having variations in 3-dimensions.

8. (canceled)

9. (canceled)

10. The vessel of claim 4 wherein the ducts in (a) of claim 4 are aligned with variations in a 2-dimensions and 3-dimensional ridges are located within these ducts.

11. (canceled)

12. The vessel of claim 4 wherein the 3-D ridges in part (a) are protruding forms on the inner surface of the ducts.
